(19) United States
(12) Patent Application Publication
(10) Pub. No.: US 2024/0120116 A1
(43) Pub. Date: Apr. 11, 2024

(54) DEVICES, SYSTEMS, AND METHODS FOR THE ENHANCED OPERATION OF HYDRAULIC CONTROL UNITS OF A CONTROL ROD DRIVE MECHANISM TO REGULATE NUCLEAR FLUX IN A REACTOR CORE

(71) Applicant: Westinghouse Electric Company LLC, Cranberry Township, PA (US)

(72) Inventors: Christopher P. MEIER, Export, PA (US); Adam M. LAUBHAM, Cranberry Township, PA (US)

(73) Assignee: Westinghouse Electric Company LLC, Cranberry Township, PA (US)

(21) Appl. No.: 18/045,562

(22) Filed: Oct. 11, 2022

(51) Int. Cl. G21C 7/16; G21C 17/108

(52) U.S. Cl. CPC G21C 7/16; G21C 17/108

(57) ABSTRACT

A hydraulic control unit (“HCU”) configured to control a control rod drive mechanism (“CRDM”) configured to control the nuclear flux produced by a nuclear reactor is disclosed herein. The HCU can include a plurality of valves configured to attenuate a fluid pressure within the CRDM, wherein the attenuation of the fluid pressure is configured to cause a control rod of the CRDM to be inserted or withdrawn from a reactor vessel of the nuclear reactor, and a control circuit including a plurality of relay interfaces, wherein each relay of the plurality of relay interfaces is electrically coupled to a valve of the plurality of valves, a controller electrically coupled to the plurality of relay interfaces, and a communications circuit communicably coupled to a header controller, wherein the communications circuit is configured to transmit and receive signals between the controller and the header controller.

### FIELD

The present disclosure is generally related to nuclear power generation and, more particularly, is directed to improved hydraulic control units for a control rod drive mechanism configured to regulate flux activity within a boiling water reactor core.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a hydraulic control unit (“HCU”) configured to control a control rod drive mechanism (“CRDM”) configured to control the nuclear flux produced by a nuclear reactor is disclosed. The HCU can include a plurality of valves configured to attenuate a fluid pressure within the CRDM, wherein the attenuation of the fluid pressure is configured to cause a control rod of the CRDM to be inserted or withdrawn from a reactor vessel of the nuclear reactor, and a control circuit including a plurality of relay interfaces, wherein each relay of the plurality of relay interfaces is electrically coupled to a valve of the plurality of valves, a controller electrically coupled to the plurality of relay interfaces, and a communications circuit communicably coupled to a header controller, wherein the communications circuit is configured to transmit and receive signals between the controller and the header controller.

In various aspects, a system configured to control a plurality of control rod drive mechanisms (“CRDMs”) configured to control the nuclear flux produced by a nuclear reactor is disclose. The system can include a header controller, and a plurality of hydraulic control units (“HCUs”), wherein each HCU of the plurality of HCUs includes a plurality of valves configured to attenuate a fluid pressure within a CRDM of the plurality of CRDMs, wherein the attenuation of the fluid pressure is configured to cause a control rod of the CRDM of the plurality of CRDMs to be inserted or withdrawn from a reactor vessel of the nuclear reactor, and a control circuit including: a plurality of relay interfaces, wherein each relay of the plurality of relay interfaces is electrically coupled to a valve of the plurality of valves, a controller electrically coupled to the plurality of relay interfaces, and a communications circuit communicably coupled to a header controller, wherein the communications circuit is configured to transmit and receive signals between the controller and the header controller.

In various aspects, a method of controlling a nuclear flux produced by a nuclear reactor is disclosed. The method can include receiving, via a control circuit of a hydraulic control unit (“HCU”), a signal from a rod drive control system (“RDCS”) module, generating, via the control circuit of the HCU, an operations sequence based on the received signal, attenuating, via the control circuit of the HCU, a fluid pressure within a control rod drive mechanism (“CRDM”) via the plurality of valves, such that the fluid pressure causes a control rode of the CRDM to perform the generated operation sequence, detecting, via the control circuit of the HCU, a current associated with each valve of a plurality of valves of the HCU, detecting, via the control circuit of the HCU, a voltage associated with each valve of the plurality of valves of the HCU, determining, via the control circuit of the HCU, a parameter associated with each valve of the plurality of valves of the HCU based on the detected voltage and the detected current, and determining, via the control circuit of the HCU, a status of the operation sequence based on the determined parameter.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a sectioned view of a control rod drive mechanism (“CRDM”) configured for enhanced operation via a hydraulic control unit (“HCU”), in accordance with at least one non-limiting aspect of the present disclosure;

FIG. 2 illustrates an isometric view of the HCU of the CRDM of FIG. 1, in accordance with at least one non-limiting aspect of the present disclosure;

FIGS. 3A and 3B (collectively “FIG. 3”) illustrate a circuit schematic of a control circuit of the HCU of FIG. 2, in accordance with at least one non-limiting aspect of the present disclosure;

FIG. 4 illustrates a chart indicative of an enhanced HCU operation enabled by the control circuit of FIG. 3, in accordance with at least one non-limiting aspect of the present disclosure;

FIG. 5 illustrates another chart indicative of an enhanced HCU operation enabled by the control circuit of FIG. 3, in accordance with at least one non-limiting aspect of the present disclosure;

FIGS. 6A and 6B illustrate a circuit schematic for a controller of a system configured to interface with a plurality of HCUs, in accordance with at least one non-limiting aspect of the present disclosure; and

FIG. 7 illustrates a method of enhancing the operation of a HCU, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

In the following description, reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (“DSP”), programmable logic device (“PLD”), programmable logic array (“PLA”), or field programmable gate array (“FPGA”), state machine circuitry, firmware that stores instructions executed by programmable circuitry, and any combination thereof. The control circuit may, collectively or individually, be embodied as circuitry that forms part of a larger system, for example, an integrated circuit (“IC”), an application-specific integrated circuit (“ASIC”), a system on-chip (“SoC”), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof. Additionally, it shall be appreciated that, as referenced herein, any specific type of control circuit can be effectively interchanged with any of the control circuits described above.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., non-volatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

Before explaining various aspects of the articulated manipulator in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

Generally, within a nuclear fission reactor, neutron flux is the primary quantity measured to control a nuclear reaction. Thus, regulation of neutron flux within a nuclear reactor is essential for safe and efficient operation of the nuclear reactor. The can be accomplished via a control rod drive mechanism (“CRDM”). A CRDM can include numerous control rods that include neutron absorbers designed to absorb neutrons, thereby regulating the flux within the reactor core. Each control rod of the CRDM can be driven by a hydraulic control unit (“HCU”), which contains the required valves and hydraulic system connections to drive each control rod of the CRDM for insertion and withdrawal into the reactor. The selective insertion and withdrawal of one or more control rods can properly regulate the flux depending on the circumstances. For example, each HCU can include up to four directional control valves (“DCVs”), which operate in a fixed sequence to control a hydraulic force such that the control rod is selectively inserted into and withdrawn from the reactor under normal use conditions. Alternately, each HCU can include valves and accumulators configured to rapidly insert the control rods such that the reactor is placed into a safe condition in a rapid emergency shutdown, such as safety control rod axe man (“SCRAM”) scenario. Such SCRAM operations are performed independent of normal use conditions.

DCV control is accomplished on a per control rod basis. For example, when not in motion, the rod is held in place with a collet piston that is engaged into the notched index rod. However, a sequence of DCV controls can relieve a locking pressure on a collet piston of any particular control rod when motion is desired. Additionally, DCV control and local parameter monitoring is typically accomplished by a local control circuit communicably coupled to the HCU. This control circuit responds to motion commands from the overall rod drive control system, which are developed from operator actions and receives monitored parameters for display via a control system. However, conventional systems implement control circuits that are coupled to hundreds of control rod HCUs and thus, serve as a single point of control and failure. In other words, conventional HCU control circuits are only capable of coarsely controlling a CRDM because they must properly route control signals to each HCU before each control rod is properly activated. If a conventional control circuit fails, moreover, that single point of failure can result in the loss of control of numerous HCUs and thus, and inability to deploy the control rods to regulate the flux of the nuclear reactor. Accordingly, there is a need for devices, systems, and method for the enhanced operation of HCUs of a CRDM to regulate nuclear flux in a reactor core.

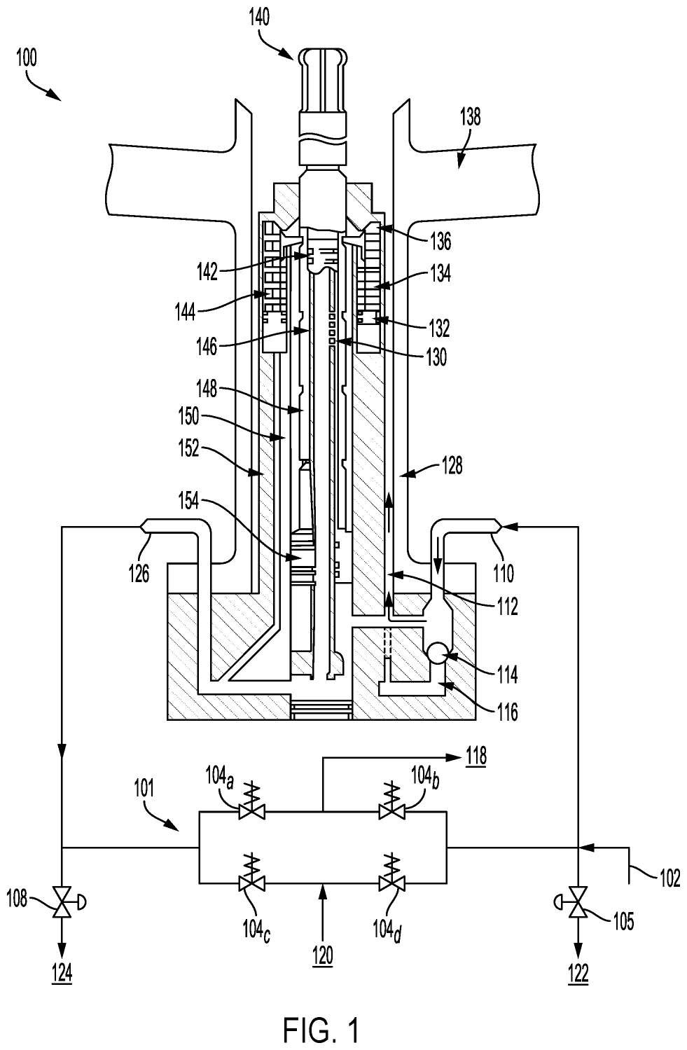

Referring now to FIG. 1, a sectioned view of a CRDM 100 configured for enhanced operation via a HCU 101 is depicted in accordance with at least one non-limiting aspect of the present disclosure. According to the non-limiting aspect of FIG. 1, the CRDM 100 can include a water line 102 and a charging water header 122 and a drive water header 120 in fluid communication with an HCU in fluid communication with an insert line 110 and a withdraw line 126. The HCU 101 can include one or more DCVs 104_{a-d} configured to open and close in a variety of sequences in order to attenuate a fluid pressure applied to a collet piston 132 of the CRDM 100, thereby controlling the insertion and withdrawal of the control rod from a reactor core, as desired. The bottom of the reactor vessel 138 is further depicted in FIG. 1. Specifically, the HCU 101 of FIG. 1 includes four DCVs 104_{a-d} configured to control the fluid pressure to selectively insert and/or withdraw the control rod from the reactor core; however, according to other non-limiting aspects, the HCU 101 can include any number of DCVs 104_{a-d} according to user preference and/or intended application.

Still referring to FIG. 1, the CRDM 100 can further include a SCRAM inlet valve 105 and a SCRAM outlet valve 108 configured for an emergency protocol wherein the control rod must be rapidly inserted into the reactor vessel 138. For example, water supplied to the charging header 122 during a SCRAM charging creates a high flow signal that results in the appropriate fluid pressure being applied to the collet piston 132. Moreover, a cooling orifice 112, a ball check valve 114, and reactor pressure check valve 116 can be further implemented to ensure the fluid and/or fluid pressure controlled by the HCU 101 effectively drives the control rod into and out of the reactor vessel 138. An exhaust header 118 can further ensure back pressure caused by the fluid is not introduced back into the HCU 101.

In further reference to FIG. 1, the CRDM 100 can include a number of mechanisms positioned within a structure in order to effectively insert and withdraw a control rod into and out of the reactor core. For example, the CRDM 100 can include a housing 128, an outer tube 152, an inner cylinder 150, and an index tube 148 configured to accommodate a drive piston 154 and piston tube 146 with buffer orifices 130 for proper alignment and actuation. A collet piston 132 with collet fingers 144 and a collet spring 134 can be positioned about the piston and configured to drive the control rod into and out of the reactor vessel 138 as desired. A guide cap 136 and stop piston 142. The CRDM can further include a control rod coupling device, or SPUD 140 configured to accommodate the control rod for insertion and withdrawal into and out of the reactor vessel 138 via the drive piston 154, in response to the fluid pressure applied via the HCU 101—and more specifically, the DCVs 104_{a-d} of the HCU 100—in varying operating scenarios.

Referring now to FIG. 2, an isometric view of the HCU 101 of the CRDM 100 of FIG. 1 is depicted in accordance with at least one non-limiting aspect of the present disclosure. According to the non-limiting aspect of FIG. 2, the HCU 101 can include a frame 202 configured to accommodate the various fluid components and various valve assemblies required to divert a fluid pressure to the insert line 110, the withdraw line 126, and the SCRAM inlet and outlet valves 105, 108 such that the CRDM 100 actuates the control rod in accordance with user preference and/or intended application. For example, the HCU 101 can include a SCRAM water accumulator 204, an inlet SCRAM valve and actuator 208, an isolation valve SCRAM discharge riser 210, an isolation valve cooling water riser 212, an isolation valve insert riser 214, an isolation valve exhaust riser 216, an isolation valve SCRAM valve for pilot air 218, a charging water riser 220, an isolation valve withdrawal riser 222, an isolation valve drive water riser 224, a SCRAM pilot valve assembly 226, an outlet SCRAM valve and actuator 228, a shutoff valve water accumulator drain 230, a SCRAM accumulator cylinder 232, an accumulator pressure indicator 234, a cartridge valve accumulator for charging 236 and/or an accumulator instrumentation assembly 238, amongst other components. In summary, most of the components of the HCU 101 of FIG. 1 can be dedicated to routing the desired fluid pressure to the various components of the CRDM 100 (FIG. 1) for the appropriate SCRAM functionality and/or normal use operations.

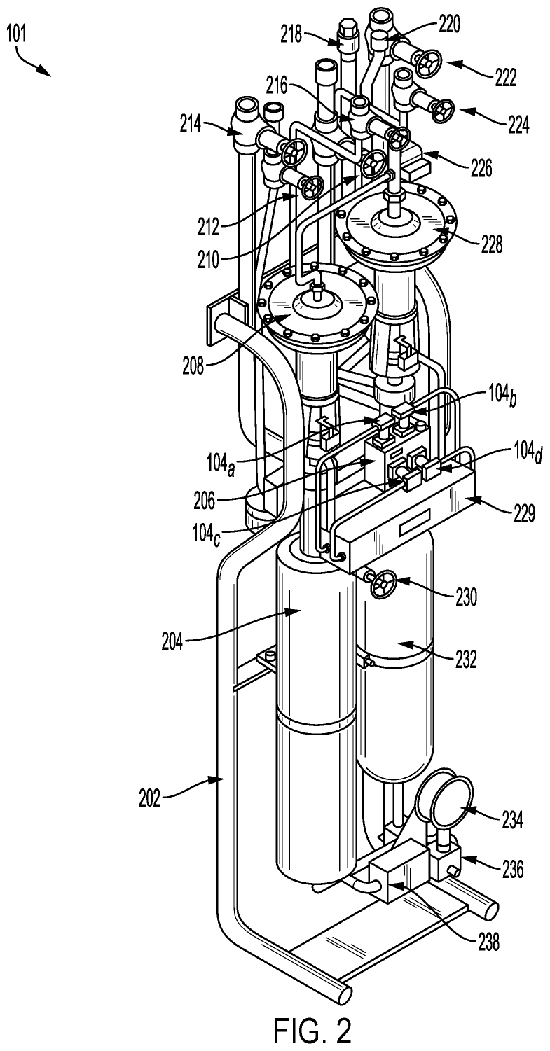

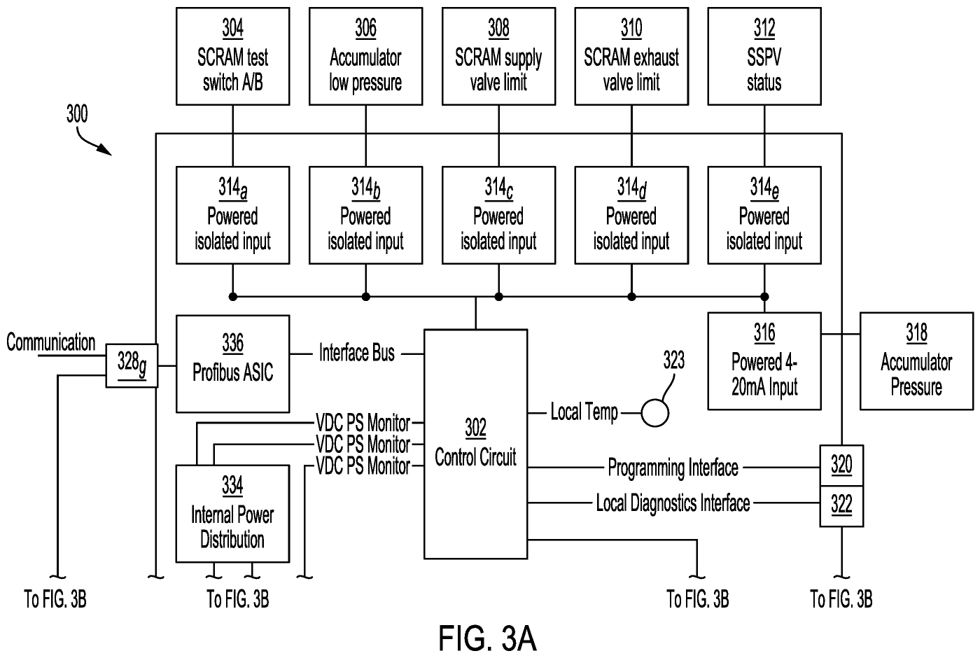

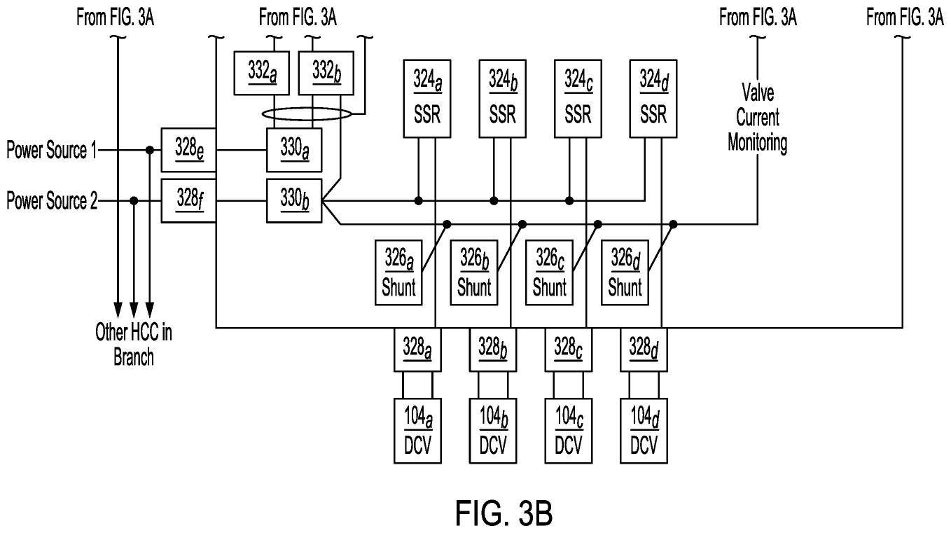

However, according to the non-limiting aspect of FIG. 2, the DCVs 104_{a-d} of the HCU 101 are depicted in further detail. For example, the HCU 101 can include two inserts DCVs 104ₐ, 104_{d}, a withdraw DCV 104_{b}, and/or a withdraw and settle DCV 104_{c}. The DCVs 104_{a-d} of the HCU 101 can be coupled to a manifold 206 and a wiring trough assembly 229. For example, the valve manifold 206 can be configured to converge the fluid lines DCVs 104_{a-d} into one or more consolidated lines for inlet and/or outlets to upstream and/or downstream components. According to some non-limiting aspects, the DCVs 104_{a-d} can include solenoids. As such, the DCVs 104_{a-d} can be electrically coupled to a wiring trough assembly 229 can be configured to route the electrical wiring to the various DCVs 104_{a-d}. However, according to the present disclosure, the wiring trough assembly 229 can further include a control circuit, such as the control circuit 300 of FIG. 3, which is configured to cause the DCVs 104_{a-d} to insert and/or withdraw the control rod of a particular CRDM 100 (FIG. 1) into and from the reactor vessel 138 (FIG. 1). In other words, the HCU 101 can function as a mechanical/electrical assembly containing and configured to enhance operation of the DCVs 104_{a-d} valves and thus, operation of the CRDM 100 (FIG. 1), as will be described in further detail herein.

Referring now to FIG. 3, a circuit schematic of a control circuit 300 of the HCU 101 of FIG. 2 is depicted in accordance with at least one non-limiting aspect of the present disclosure. As previously discussed, the control circuit 300 of FIG. 3 can be incorporated into the wiring trough assembly 229 of the HCU 101 of FIG. 2, such that the control circuit 300 is dedicated to operating a single CRDM 100 (FIG. 1). The control circuit 300 of FIG. 3 enables specific control of a particular CRDM, which provides more precise control and eliminates the single point of failure common in conventional HCUs and conventional CRDMs. In other words, the control circuit 300 of FIG. 3 enhances the operation of the CRDM 101 and thus, can improve the regulation of a nuclear flux within the reactor vessel 138 (FIG. 1).

According to the non-limiting aspect of FIG. 3, the control circuit 300 can include a controller 302, such as a microprocessor. However, according to other non-limiting aspects, the controller 302 can include one or more processing cores, processing units, processors, and/or a DSPs, amongst other devices capable of controlling the functionality of the HCU 101. According to still other non-limiting aspects, the controller 302 can include a logic-based device, such as a PLD, a PLA, and/or a FPGA, amongst others. The control circuit can further include one or more relay interfaces 324_{a-d}, wherein each relay interfaces 324_{a-d} can be electrically coupled to a corresponding DCVs 104_{a-d} of the HCU 101 (FIG. 2) via one or more connectors 328_{a-d}. Additionally, each relay interface 324_{a-d} can be electrically coupled to a shunt resistor 326_{a-d} configured to monitor a voltage drop across each DCV 104_{a-d} of the HCU 101 (FIG. 2). The control circuit 300 can further include a plurality of isolated digital inputs 314_{a-d} and a powered loop input 316 (e.g., 4-20 mA, etc.).

For example, according to the non-limiting aspect of FIG. 3, each isolated input 314_{a-d} can be coupled to circuitry configured to provide the controller 302 with various inputs, such as a SCRAM test switch 304, an accumulator pressure 306 (both low and high), a SCRAM supply valve limit 310, and/or a SCRAM solenoid pilot valve (“SSPV”) status 312. Also, the powered loop input 316 (e.g., 4-20 mA, etc.) can be electrically coupled to a pressure sensor 318 positioned to monitor pressure within the accumulator. The powered loop input 316, for example, can also enable any other compatible sensor to operate using power received from a 4-20 mA process signal. Moreover, the controller 302 can be electrically coupled to a temperature sensor 323 configured to monitor a local temperature associated with the system. The control circuit 300 can further include various connectors 320, 322 can be configured for programming (e.g., universal serial bus) and/or diagnostics (e.g., RJ45, etc.) interfaces for the controller 302.

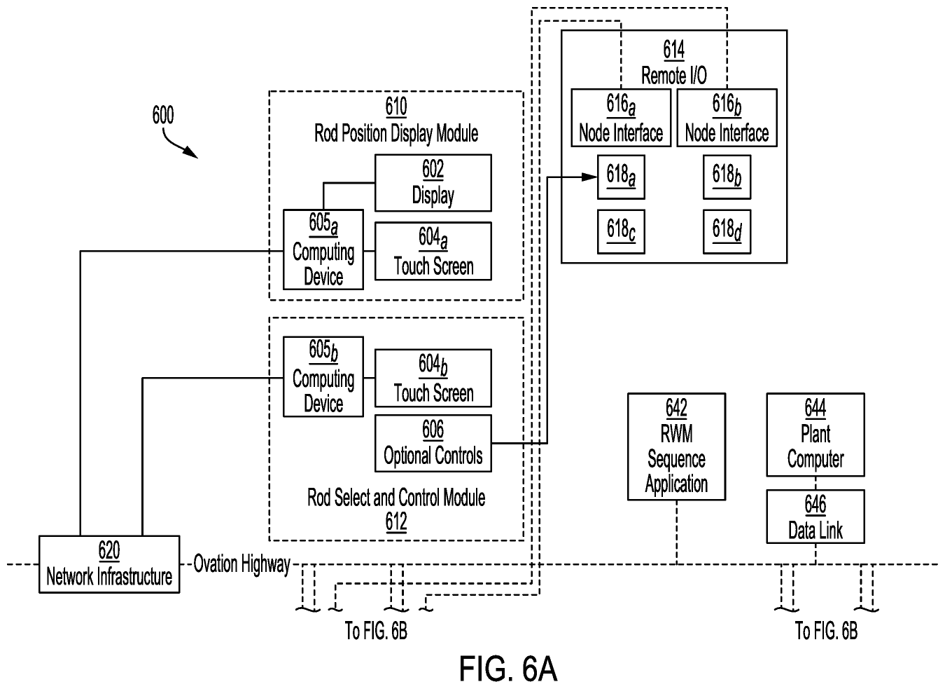

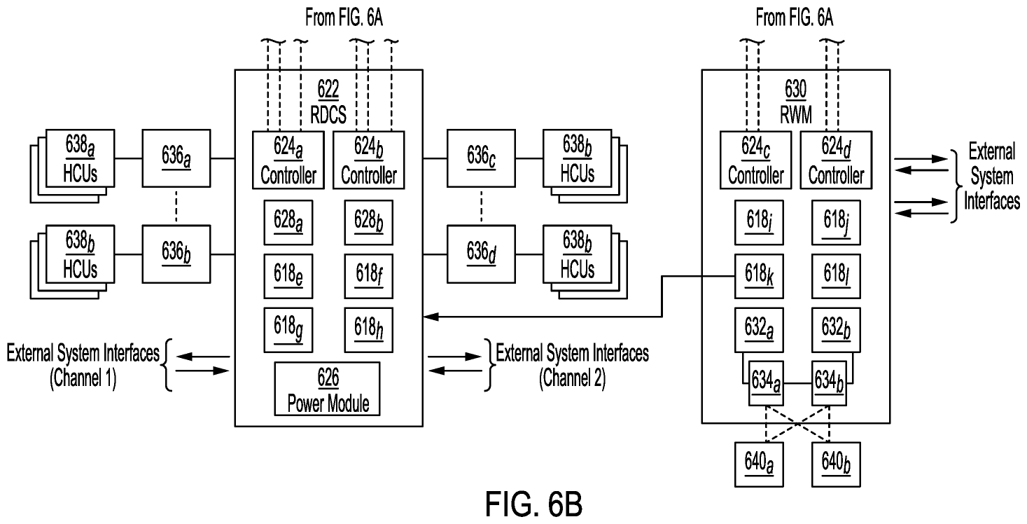

In further reference to FIG. 3, the control circuit 300 can further include a communication circuit 336 configured to establish communication between the controller 302 and the overall rod drive control system 622 (and specifically, the head controller 624 (FIG. 6) via input/output components 618_{a-d} (FIG. 6) and one or more communication modules 628ₐ, 628_{b} (FIG. 6) via an interface bus and communications connector 328_{g}. For example, according to some non-limiting aspects, the communication circuit 336 can include the implementation of one or more standard fieldbus communication protocols. The use of standard fieldbus communication protocols, for example, can enable the control circuit 300 to operate independent of a proprietary communication protocols, which allows for enhanced reliability and redundancy throughout the communication interface.

Additionally, the control circuit 300 of FIG. 3 can be configured to be electrically coupled to one or more external power sources via one or more connectors 328_{g}, 328_{f}. According to the non-limiting aspect of FIG. 3, the control circuit can be electrically coupled to two power sources, providing additional redundancy that further improves the HCU 101 (FIG. 2) over conventional devices, which not only implement a single-point-of-failure for multiple HCUs but are generally powered by a single power source. Incoming power can be filtered via one or more filters 330ₐ, 330_{b} and/or routed through one or more AC/DC converters filters 332ₐ, 332_{b} prior to distribution to downstream components of the control circuit 300. For example, an internal power distribution circuit 334 can receive the filtered and converted inputs and provide them to the controller 302 and/or other peripheral components of the control circuit 300 via one or more lines. According to some non-limiting aspects, the internal power distribution circuit 334 can include a compact isolated AC to DC power supply.

As such, it shall be appreciated that the control circuit 300 of FIG. 3 distinguishes the HCU 101 (FIG. 2) and CRDM 100 (FIG. 1) from conventional devices by facilitating local HCU 101 (FIG. 2) operation and thus, more precise DCV 104_{a-d} control. However, each control circuit 300 of each HCU 101 (FIG. 2) can still communicate with and respond to a central controller for the reactor, such as the controller 600 of FIG. 6, via a standard fieldbus communication protocol. In other words, each control circuit 300 can monitor and control each HCU 101 (FIG. 2) with specificity beyond the capability of conventional systems.

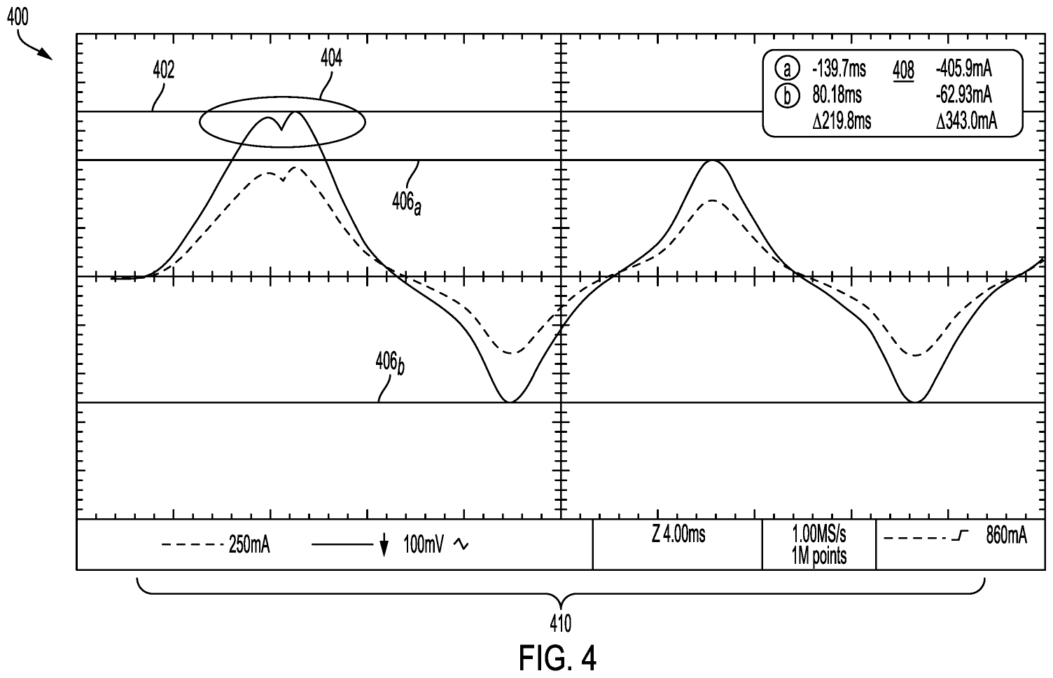

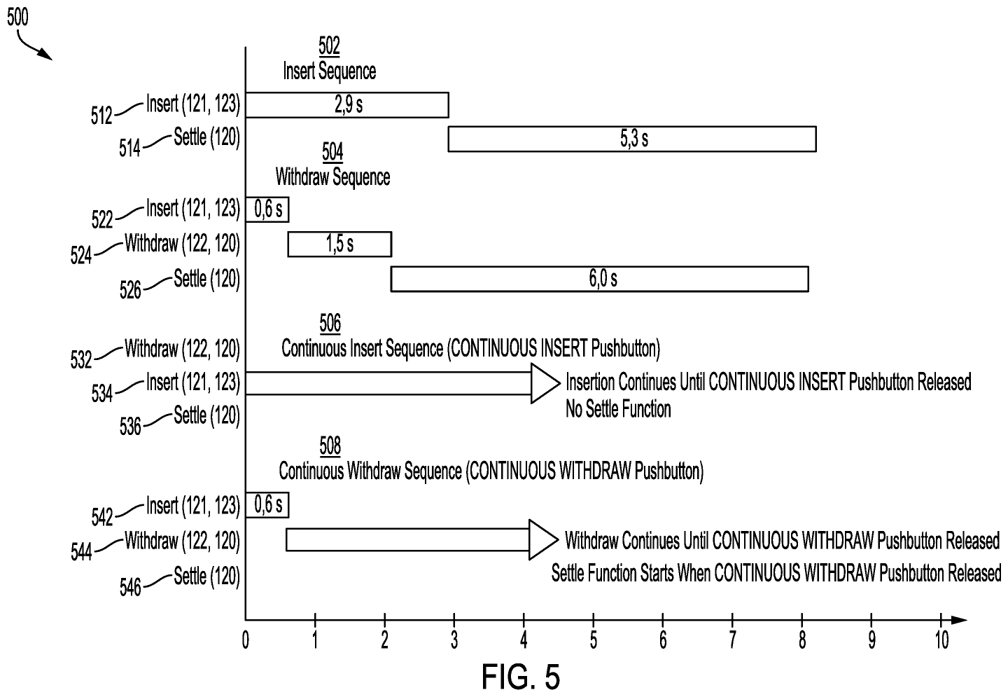

For example, the control circuit 300 of FIG. 3 can receive motion start and direction commands from the overall coordinating logic controller and internally process the timing sequence of activation of the DCVs 104_{a-d} to start a single withdrawal or insertion step, or a continuous withdrawal or insertion, as will be described in further reference to FIG. 5. Additionally, each control circuit 300 can monitor external HCU 101 (FIG. 2) process signals (e.g., limit/pressure switches, etc.) and can provide status information to the coordinating logic controller via a fieldbus interface. The control circuit 300 can further monitor the current and voltage applied to each DCV 104_{a-d} for proper waveform values and can indicate if execution is not as intended. Likewise, the control circuit 300 can monitor the current and voltage applied to the DCVs 104_{a-d} and can monitor the health and baseline operation of the DCV 104_{a-d} via resistance and temperature calculations. The control circuit 300 can further monitor the current applied to the DCVs 104_{a-d} for positive indication of solenoid activation, as will be described in further reference to FIG. 4. Furthermore, the control circuit 300 can monitor the current applied to the DCV and indicate if current exists when not demanded.

Additionally, the control circuit 300 of FIG. 3 can monitor the local power supplies and indicate if they are out of range or unavailable, and can provide indication to the coordinating logic controller. The control circuit 300 can accept adjustable setpoints from the coordinating controller via fieldbus for internal control parameters and, according to some non-limiting aspects, the control circuit 300 can automatically take any actions, such as blocking a rod motion if abnormal conditions are detected. All abnormal conditions can be transmitted to the coordinating controller for system level analysis and further commands.

Referring now to FIG. 4, a chart 400 indicative of an enhanced HCU 101 (FIG. 2) operation enabled by the control circuit 300 of FIG. 3 is depicted in accordance with at least one non-limiting aspect of the present disclosure. For example, the control circuit 300 (FIG. 3) can capture the data and detect the indicated parameters (e.g., notch 404) depict in the chart 400 for use in association with the aforementioned external HCU 101 (FIG. 2) monitoring and signal processing functions. The chart 400, for example, can depict DCV current monitoring and engagement detection features provided by the devices, systems, and methods disclosed herein. Specifically, the chart 400 of FIG. 4 illustrates the advanced monitoring capabilities provided by the control circuit 300 for FIG. 3. According to the non-limiting aspect of FIG. 4, the chart can depict a measure of the current and voltage within each solenoid valve of the DCVs 104_{a-d}, in time. For example, the chart 400 can include a depictions of a maximum 406, and a minimum 406_{b} resistance calculation for a particular solenoid. The chart 400 can further include a depiction of an initial high peak for solenoid overshoot 402 (e.g., initial readings beyond the depicted maximum 406ₐ). The chart 400 can further include one or more widgets 408, 410 configured to display important metrics associated with the solenoid being monitored by the control circuit 300 of FIG. 3. For example, a first widget 408 can include numerical representations of the expected voltage, resistance, and change in time associated with each of the maximum 406ₐ and a minimum 406_{b} calculation depicted in the chart 400. Likewise a second widget 410 can include similar metrics related to a particular voltage, resistance, or impedance measurement at a particular time.

In further reference to FIG. 4, it shall be appreciated that the control circuit 300 of FIG. 3 can be used to determine a change in inductance within a solenoid valve of each of the DCVs 104_{a-d}, in time. For example, the control circuit 300 of FIG. 3 enables the control of four DCVs 104_{a-d}, to open and close the fluid lines in order to insert and/or withdraw the control rods. According to a non-limiting aspect wherein the DCVs 104_{a-d} include solenoid valves, each DCV 104_{a-d} can generate a change in inductance which can be monitored to determine that the valves are functioning properly. According to non-limiting aspects wherein the control circuit 400 includes a microcontroller, the control circuit 300 can generate feedback based on the measured inductance to determine that a DCV 104_{a-d} functioned properly and a plunger actually moved.

For example, according to the non-limiting aspect of FIG. 4, the chart depicts a notch 404, which can be detected by the control circuit 300 (FIG. 3) via its monitoring, and may only occur upon the initial engagement of a plunger via proper operation of the DCV 104_{a-d}. According to non-limiting aspects wherein the DCVs 104_{a-d} include a solenoid valve, the notch 404 can be associated with a change of inductance with the DCV 104_{a-d} resulting from the initial engagement of the plunger within the solenoid valve. In other words, the notch 404 may appear once a static friction is overcome. The plunger subsequently remains seated and thus, the chart 400 does not depict any additional “glitches” or notches 404 until power has been shut off and the spring unseats the plunger. Over time, if the notch 404 (or engagement “glitch”) moves to the left of the chart 400, it can serve as an indication that the spring may be getting weaker because the current threshold is lowering. According to other non-limiting aspects, an operating temperature of each of the DCVs 104_{a-d} can be monitored by monitoring the current and the voltage to generate resistance and temperature, based on a constant of the material implemented (e.g., copper, etc.). In other words, the chart 400 of FIG. 4 can serve as a health check for each of the DCVs 104_{a-d}, which can be individually monitored via the control circuit 300 of FIG. 3. Thus, the control circuit 300 of FIG. 3 can be utilized to provide a more intelligent and data-based approach to preventative maintenance, thereby enhancing the operation of the HCUs 101 (FIG. 2) and/or CRDM 100 (FIG. 1).

Referring now to FIG. 5, another chart 500 indicative of an enhanced HCU 101 (FIG. 2) operation enabled by the control circuit 300 of FIG. 3 is depicted in accordance with at least one non-limiting aspect of the present disclosure. The chart 500 can depict, for example, the DCV actuation timing. Specifically, the chart 500 of FIG. 5 depicts the control of the DCVs 104_{a-d} of the HCU 101 of FIG. 2. Accordingly, the chart 500 depicts four modes of operation, including an insert sequence 502, a withdraw sequence 504, a continuous insert sequence 506, and a continuous withdraw sequence 508, along with a respective timing for each mode of operation. For example, according to the non-limiting aspect of FIG. 5, the insert sequence 502 can include an insert operation 512 for a duration of 2.9 seconds and a settle operation 514 for a duration of 5.3 seconds. The withdraw sequence 504 can include an insert operation 522 for a duration of 0.6 seconds, a withdraw operation 524 for a duration of 1.5 seconds, and a settle operation 526 for a duration of 6.0 seconds. Of course, it shall be appreciated that any specific references to particular times or durations are merely illustrative and may differ according to other non-limiting aspects. The continuous insert sequence 506 can include an instruction to continuously insert one or more control rods until commanded to halt, such as via the release of a continuous insert push button. The continuous withdraw sequence 508 can include an instruction to continuously withdraw one or more control rods until commanded to halt, such as via the release of a continuous insert push button. Once the command to halt the continuous withdraw sequence 508 has been issued, a settle function may commence. According to the non-limiting aspect of FIG. 5, each of the number 120-123 can correspond to a particular DCV 104_{a-d}, of the HCU 101, for example.

Conventional systems implemented a single controller at the head end to control the insertion and/or withdrawal of a particular control rod. However, the control circuit 300 (FIG. 3) of the HCU 101 (FIG. 2) enables fast motions to occur at the HCU 101 (FIG. 2) local level. This enables a much higher resolution of control of each particular control rod and reduces lag and possible interruptions between the head and the actual HCU 101 (FIG. 2) being moved, enabling the control circuit 300 (FIG. 3) to move rods within the millisecond range. Notably, this provides a control rod motion reliability enhancement because it eliminates extra mechanics in the conventional control path. In other words, via the control circuit 300 of FIG. 3, a user can adjust set points at the HCU 101 (FIG. 1) level—a lower level of the overall assembly—which reduces the necessity for generic timing and enables the use of a specific timing for each control rod. The control circuit 300 of FIG. 3 has the inherent intelligence to directly control each control rod, eliminating the need for “middle-man” circuitry and subsystems to communicate control information at a granular level to the HCU 101 (FIG. 2) prior to control. For example, high-level instructions may still be required from the head controller, but detailed control is handled at the local level.

Referring now to FIG. 6, a circuit schematic for a controller 600 of a system configured to interface with a plurality of HCUs is depicted in accordance with at least one non-limiting aspect of the present disclosure. It shall be appreciated that the controller 600 can be a header controller configured to manage the various interfaces of a system comprising a plurality of HCUs, each of which having its own control circuit 300 (FIG. 3). For example, the controller 600 can included and control human-to-machine interface, external plant interfaces, and/or rod motion interlocks and/or permissives, as may be driven by system requirements. According to the non-limiting aspect of FIG. 6, the controller can include a rod position display module 610, a rod select and control module 612, a remote input/output module 614, a rod drive control system (“RDCS”) module 622, and/or a rod worth monitor (“RWM”) module 630 communicably coupled via a network infrastructure 620. In other words, the controller 600 can be configured to manage the various interfaces such that operation of the CRDMs 100 (FIG. 1) can be enhanced via more precise operation of the HCUs 101 (FIG. 2), as provided via the control circuit 300 of FIG. 3.

For example, according to the non-limiting aspect of FIG. 6, the rod position display module 610 of the controller 600 can include a first computing device 606ₐ communicably coupled to a display 602 and/or a touch screen 604ₐ, such that the rod position display module 610 can display a current position of a control rod at any given point in time. Likewise, the rod select and control module 612 can include a second computing device 606_{b} communicably coupled to a touch screen 604, and/or any other optional controls 606 such that a user can select and control a particular CRDM 100 (FIG. 1) of the system. Signals sent to and/or from the rod select and control module 612 can be transmitted to the rest of the system interfaces via the remote input/output module 614, which can include a one or more node interfaces 616ₐ, 616_{b} and one or more input/output components 618_{a-d}. In other words, the rod position display module 610, the rod select and control module 612, and the remote input/output module 614 can be configured as a human-to-machine interface for the system, such that a user may monitor and communicate with the CRDMs 100 (FIG. 1) and HCUs 101 (FIG. 2), amongst other subsystems, as required. According to some non-limiting aspects, parameters of the controller can be adjusted via the communications interface from the displays 602, 606ₐ, including operational parameters, such as timing and alarming values which may be adjustable.

Still referring to FIG. 6, the RDCS module 622 can include one or more controllers 624ₐ, 624_{b}, one or more communication modules 628ₐ, 628_{b} (e.g., fieldbus, ethernet, etc.), one or more input/output components 618ₑ₋ₕ, and/or a power module 626 collectively configured to interface with one or more pluralities of HCUs 638_{a-d} via one or more interface components 636_{a-d}. It shall be appreciated that the HCUs of the one or more pluralities of 638_{a-d} can be configured similar to the HCU 101 of FIG. 2 and thus, can include an HCU control circuit 300 as depicted and discussed in reference to FIG. 3. Additionally, the one or more interface components 636_{a-d} can be configured to communicate with one another independent of the RDCS module 622. Specifically, the one or more input/output components 618_{a-d} can be configured to communicate with several channels, wherein each channel represents an external system interface. Moreover, the one or more controllers 624ₐ, 624_{b} can be configured to communicate with the remote input/output module 614 via the network infrastructure 620, which may include a communication protocol, such as an Ethernet, for example. Of course, communications can be coordinated and/or standardized via the one or more communication circuits 628ₐ, 628_{b}.

In further reference to FIG. 6, the RWM module 630 can include one or more controllers 624_{c}, 624_{d}, one or more input/output components 618ᵢ₋ₗ, one or more electronic load controllers (“ELCs”) 632ₐ, 632_{b}, and/or one or more switches 636ₐ, 636_{b} collectively configured to provide instructions regarding the specific controls to be applied to each rod via the CRDMs 100 (FIG. 1). The one or more switches can be coupled to one or more rod position indication systems (“RPIS”) 640ₐ, 640_{b} configured to provide information and assist with rod control instruction. Specifically, the one or more input/output components 618ᵢ₋ₗ can be configured to communicate with several external system interfaces, as well as the RDCS module 622.

According to some non-limiting aspects, the controller 600 of FIG. 6 can be further configured to execute an RWM sequence application 642 that can further provide information and assist with rod control instructions. Likewise, the controller 600 of FIG. 6 can be communicably coupled to one or more plant computers 644 via a data link 646 of the network architecture 620. According to some non-limiting aspects, the controller 600 of FIG. 6 can be a custom build. According to other non-limiting aspects, the controller 600 of FIG. 6 can be implemented via a commercial off-the-shelf product. Regardless, the controller 600 of FIG. 6 can be configured to communicate with one or more pluralities of HCUs 638_{a-d} to manage overall system coordination (e.g., via the RDCS module 622) and to provide and/or receive feedback from a human-to-machine interface (e.g., via the rod position display module 610, the rod select and control module 612, and the remote input/output module 614). Meanwhile, the lower level control circuit 300 (FIG. 3) can be configured to control the detailed functions for each HCU 101 (FIG. 2), including opening and closing of individual DCVs 104_{a-d} (FIG. 1), monitoring, and managing of systems and alarms. Likewise, according to non-limiting aspects wherein the controller 600 of FIG. 6 and control circuit 300 of FIG. 3 are implemented via software-based devices (e.g., microprocessors, processors, etc.), and additional benefit can be realized via the upgrading of software or firmware. In other words, the controller 600 of FIG. 6 and control circuit 300 of FIG. 3 can be continuously improved.

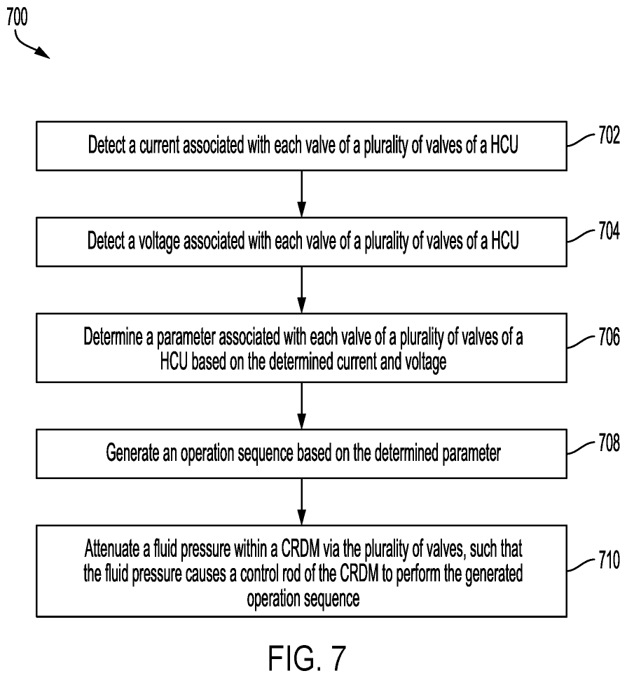

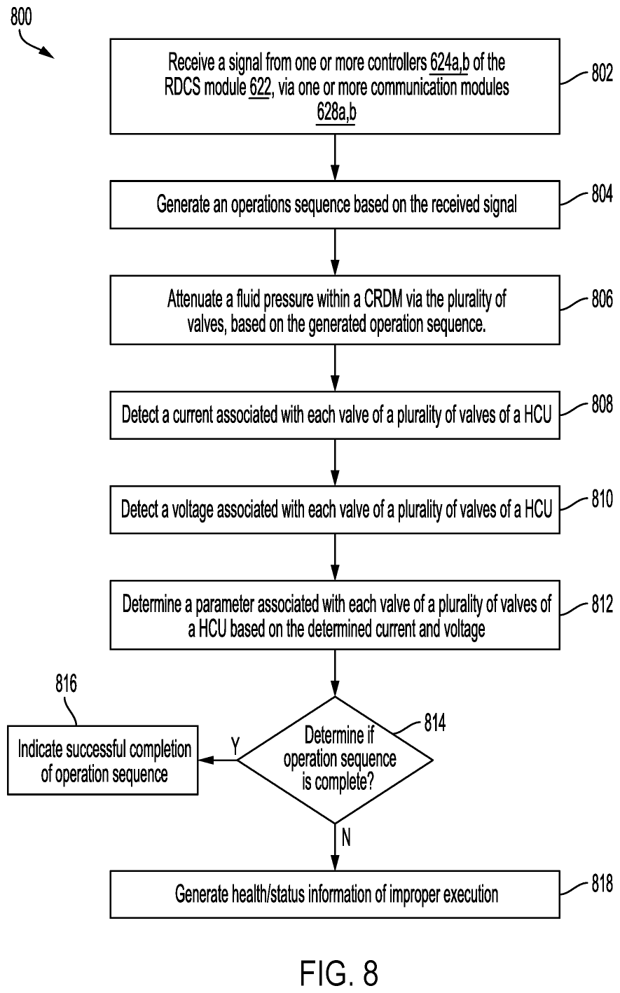

Referring now to FIG. 7, a method 700 of enhancing the operation of a HCU 101 (FIG. 2) is depicted in accordance with at least one non-limiting aspect of the present disclosure. For example, the method 700 of FIG. 7 can be performed by a control circuit 300 (FIG. 3) of an HCU 101 (FIG. 2). According to the non-limiting aspect of FIG. 7, the method 700 can include detecting 702 a current associated with each valve 104_{a-d} (FIG. 2) of a plurality of valves 104_{a-d}(FIG. 2) of the HCU 101 (FIG. 2) and detecting 704 a voltage associated with each valve 104_{a-d} (FIG. 2) of the plurality of valves 104_{a-d} (FIG. 2) of the HCU 101 (FIG. 2). The method 700 can further include determining 706 a parameter associated with each valve 104_{a-d} (FIG. 2) of the plurality of valves 104_{a-d} (FIG. 2) of the HCU 101 (FIG. 2) based on the detected voltage and the detected current and generating 708 an operation sequence 502, 504, 506, 508 (FIG. 5) based on the determined parameter. Finally, the method 700 can include attenuating 710 a fluid pressure within a CRDM 100 (FIG. 1) via the plurality of valves 104_{a-d} (FIG. 2), such that the fluid pressure causes a control rod of the CRDM 100 (FIG. 1) to perform the generated operation sequence 502, 504, 506, 508 (FIG. 5).

Referring now to FIG. 8, another method 800 of enhancing the operation of a HCU 101 (FIG. 2) is depicted in accordance with at least one non-limiting aspect of the present disclosure. For example, the method 800 of FIG. 8 can be performed by a control circuit 300 (FIG. 3) of an HCU 101 (FIG. 2). According to the non-limiting aspect of FIG. 8, the method 800 can include receiving 802 a signal from one or more controllers 624ₐ, 624_{b} (FIG. 6) of the RDCS module 622 (FIG. 6), via one or more communication modules 628ₐ, 628_{b} (FIG. 6). The method 800 can further include generating 804 an operation sequence 502, 504, 506, 508 (FIG. 5) based on the received signals and attenuating 806 a fluid pressure within a CRDM 100 (FIG. 1) via the plurality of valves 104_{a-d} (FIG. 2), such that the fluid pressure causes a control rod of the CRDM 100 (FIG. 1) to perform the generated operation sequence 502, 504, 506, 508 (FIG. 5). During that process, the method 800 can include detecting 808 a current associated with each valve 104_{a-d} (FIG. 2) of a plurality of valves 104_{a-d} (FIG. 2) of the HCU 101 (FIG. 2) and detecting 810 a voltage associated with each valve 104_{a-d} (FIG. 2) of the plurality of valves 104_{a-d} (FIG. 2) of the HCU 101 (FIG. 2). Then, if necessary, the method can include determining 812 a parameter associated with each valve 104_{a-d} (FIG. 2) of the plurality of valves 104_{a-d} (FIG. 2) of the HCU 101 (FIG. 2) based on the detected voltage and the detected current. Based on the determined parameter, the method 800 can include determining 814 if the operation sequence is complete and/or was successful. If the operation was successful, the method 800 can include indicating 816 the successful completion of operation sequence. If the operation was not successful, the method 800 can include generating 818 health and/or status information associated with the improper execution of the operation sequence.

Various aspects of the subject matter described herein are set out in the following numbered clauses:

Clause 1: A hydraulic control unit (“HCU”) configured to control a control rod drive mechanism (“CRDM”) configured to control the nuclear flux produced by a nuclear reactor, the HCU including: a plurality of valves configured to attenuate a fluid pressure within the CRDM, wherein the attenuation of the fluid pressure is configured to causes a control rod of the CRDM to be inserted or withdrawn from a reactor vessel of the nuclear reactor; and a control circuit including: a plurality of relay interfaces, wherein each relay of the plurality of relay interfaces is electrically coupled to a valve of the plurality of valves; a controller electrically coupled to the plurality of relay interfaces; and a communications circuit communicably coupled to a header controller, wherein the communications circuit is configured to transmit and receive signals between the controller and the header controller.

Clause 2. The HCU according to clause 1, wherein the control circuit is configured to detect a current associated with each valve of the plurality of valves and a voltage associated with each valve of the plurality of valves.

Clause 3. The HCU according to either of clauses 1 or 2, wherein the control circuit is further configured to determine a resistance associated with each valve of the plurality of valves, based on a material constant associated with each valve of the plurality of valves, the detected current associated with each valve of the plurality of valves, and the detected voltage associated with each valve of the plurality of valves.

Clause 4. The HCU according to any of clauses 1-3, wherein the control circuit is further configured to determine a temperature associated with each valve of the plurality of valves, based on a material constant associated with each valve of the plurality of valves, the detected current associated with each valve of the plurality of valves, and the detected voltage associated with each valve of the plurality of valves.

Clause 5. The HCU according to any of clauses 1-4, wherein at least one of the plurality of valves is a solenoid valve.

Clause 6. The HCU according to any of clauses 1-5, wherein the control circuit is further configured to determine an inductance associated with the at least one valve of the plurality of valves, based on the detected current associated with each valve of the plurality of valves.

Clause 7. The HCU according to any of clauses 1-6, wherein the determination is further based on a material constant associated with each valve of the plurality of valves.

Clause 8. The HCU according to any of clauses 1-7, wherein the control circuit is configured to cause the plurality of valves to attenuate the fluid pressure within the CRDM such that the control rod performs at least one of an insertion sequence, a withdrawal sequence, a continuous insertion sequence, and a continuous withdrawal sequence, or combinations thereof.

Clause 9. The HCU according to any of clauses 1-8, wherein each of the insertion sequence, the withdrawal sequence, the continuous insertion sequence, and the continuous withdrawal sequence can commence upon receiving a general motion demand command from the header controller.

Clause 10. The HCU according to any of clauses 1-9, wherein each of the insertion sequence, the withdrawal sequence, the continuous insertion sequence, and the continuous withdrawal sequence includes at least one operation, and wherein the at least one operation of the insertion sequence, the withdrawal sequence, the continuous insertion sequence includes a predetermined adjustable time determined by the control circuit.

Clause 11. A system configured to control a plurality of control rod drive mechanisms (“CRDMs”) configured to control the nuclear flux produced by a nuclear reactor, the system including a header controller, and a plurality of hydraulic control units (“HCUs”), wherein each HCU of the plurality of HCUs includes a plurality of valves configured to attenuate a fluid pressure within a CRDM of the plurality of CRDMs, wherein the attenuation of the fluid pressure is configured to causes a control rod of the CRDM of the plurality of CRDMs to be inserted or withdrawn from a reactor vessel of the nuclear reactor, and a control circuit including: a plurality of relay interfaces, wherein each relay of the plurality of relay interfaces is electrically coupled to a valve of the plurality of valves, a controller electrically coupled to the plurality of relay interfaces, and a communications circuit communicably coupled to a header controller, wherein the communications circuit is configured to transmit and receive signals between the controller and the header controller.

Clause 12. The system according to clause 11, wherein the control circuit is configured to detect a current associated with each valve of the plurality of valves and a voltage associated with each valve of the plurality of valves.

Clause 13. The system according to either of clauses 11 or 12, wherein the control circuit is further configured to determine a resistance associated with each valve of the plurality of valves, based on a material constant associated with each valve of the plurality of valves, the detected current associated with each valve of the plurality of valves, and the detected voltage associated with each valve of the plurality of valves.

Clause 14. The system according to any of clauses 11-13, wherein the control circuit is further configured to determine a temperature associated with each valve of the plurality of valves, based on a material constant associated with each valve of the plurality of valves, the detected current associated with each valve of the plurality of valves, and the detected voltage associated with each valve of the plurality of valves.

Clause 15. The system according to any of clauses 11-14, wherein at least one of the plurality of valves is a solenoid valve.

Clause 16. The system according to any of clauses 11-15, wherein the control circuit is further configured to determine an inductance associated with the at least one valve of the plurality of valves, based on the detected current associated with each valve of the plurality of valves and the detected voltage associated with each valve of the plurality of valves.

Clause 17. The system according to any of clauses 11-16, wherein the control circuit is configured to cause the plurality of valves to attenuate the fluid pressure within the CRDM such that the control rod performs at least one of an insertion sequence, a withdrawal sequence, a continuous insertion sequence, and a continuous withdrawal sequence, or combinations thereof.

Clause 18. A method of controlling a nuclear flux produced by a nuclear reactor, the method including receiving, via a control circuit of a hydraulic control unit (“HCU”), a signal from a rod drive control system (“RDCS”) module, generating, via the control circuit of the HCU, an operations sequence based on the received signal, attenuating, via the control circuit of the HCU, a fluid pressure within a control rod drive mechanism (“CRDM”) via the plurality of valves, such that the fluid pressure causes a control rode of the CRDM to perform the generated operation sequence, detecting, via the control circuit of the HCU, a current associated with each valve of a plurality of valves of the HCU, detecting, via the control circuit of the HCU, a voltage associated with each valve of the plurality of valves of the HCU, determining, via the control circuit of the HCU, a parameter associated with each valve of the plurality of valves of the HCU based on the detected voltage and the detected current, and determining, via the control circuit of the HCU, a status of the operation sequence based on the determined parameter.

Clause 19. The method according to clause 18, wherein the determined parameter includes at least one of a resistance associated with each valve of the plurality of valves or a temperature associated with each valve of the plurality of valves.

Clause 20. The method according to either of clauses 18 or 19, wherein the operation sequence includes at least one of an insertion sequence, a withdrawal sequence, a continuous insertion sequence, and a continuous withdrawal sequence, or combinations thereof.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A hydraulic control unit (“HCU”) configured to control a control rod drive mechanism (“CRDM”) configured to control the nuclear flux produced by a nuclear reactor, the HCU comprising:
a plurality of valves configured to attenuate a fluid pressure within the CRDM, wherein the attenuation of the fluid pressure is configured to cause a control rod of the CRDM to be inserted or withdrawn from a reactor vessel of the nuclear reactor; and
a control circuit comprising:
a plurality of relay interfaces, wherein each relay of the plurality of relay interfaces is electrically coupled to a valve of the plurality of valves;
a controller electrically coupled to the plurality of relay interfaces; and
a communications circuit communicably coupled to a header controller, wherein the communications circuit is configured to transmit and receive signals between the controller and the header controller.

2. The HCU of claim 1, wherein the control circuit is configured to detect a current associated with each valve of the plurality of valves and a voltage associated with each valve of the plurality of valves.

3. The HCU of claim 2, wherein the control circuit is further configured to determine a resistance associated with each valve of the plurality of valves, based on a material constant associated with each valve of the plurality of valves, the detected current associated with each valve of the plurality of valves, and the detected voltage associated with each valve of the plurality of valves.

4. The HCU of claim 2, wherein the control circuit is further configured to determine a temperature associated with each valve of the plurality of valves, based on a material constant associated with each valve of the plurality of valves, the detected current associated with each valve of the plurality of valves, and the detected voltage associated with each valve of the plurality of valves.

5. The HCU of claim 4, wherein at least one of the plurality of valves is a solenoid valve.

6. The HCU of claim 5, wherein the control circuit is further configured to determine an inductance associated with the at least one valve of the plurality of valves, based on the detected current associated with each valve of the plurality of valves.

7. The HCU of claim 6, wherein the determination is further based on a material constant associated with each valve of the plurality of valves.

8. The HCU of claim 1, wherein the control circuit is configured to cause the plurality of valves to attenuate the fluid pressure within the CRDM such that the control rod performs at least one of an insertion sequence, a withdrawal sequence, a continuous insertion sequence, and a continuous withdrawal sequence, or combinations thereof.

9. The HCU of claim 8, wherein each of the insertion sequence, the withdrawal sequence, the continuous insertion sequence, and the continuous withdrawal sequence can commence upon receiving a motion demand command from the header controller.

10. The HCU of claim 8, wherein each of the insertion sequence, the withdrawal sequence, the continuous insertion sequence, and the continuous withdrawal sequence comprises at least one operation, and wherein the at least one operation of the insertion sequence, the withdrawal sequence, the continuous insertion sequence comprises a predetermined adjustable time determined by the control circuit.

11. A system configured to control a plurality of control rod drive mechanisms (“CRDMs”) configured to control the nuclear flux produced by a nuclear reactor, the system comprising:
a header controller; and
a plurality of hydraulic control units (“HCUs”), wherein each HCU of the plurality of HCUs comprises:
a plurality of valves configured to attenuate a fluid pressure within a CRDM of the plurality of CRDMs, wherein the attenuation of the fluid pressure is configured to causes a control rod of the CRDM of the plurality of CRDMs to be inserted or withdrawn from a reactor vessel of the nuclear reactor; and
a control circuit comprising:
a plurality of relay interfaces, wherein each relay of the plurality of relay interfaces is electrically coupled to a valve of the plurality of valves;
a controller electrically coupled to the plurality of relay interfaces; and
a communications circuit communicably coupled to a header controller, wherein the communications circuit is configured to transmit and receive signals between the controller and the header controller.

12. The system of claim 11, wherein the control circuit is configured to detect a current associated with each valve of the plurality of valves and a voltage associated with each valve of the plurality of valves.

13. The system of claim 12, wherein the control circuit is further configured to determine a resistance associated with each valve of the plurality of valves, based on a material constant associated with each valve of the plurality of valves, the detected current associated with each valve of the plurality of valves, and the detected voltage associated with each valve of the plurality of valves.

14. The system of claim 12, wherein the control circuit is further configured to determine a temperature associated with each valve of the plurality of valves, based on a material constant associated with each valve of the plurality of valves, the detected current associated with each valve of the plurality of valves, and the detected voltage associated with each valve of the plurality of valves.

15. The system of claim 13, wherein at least one of the plurality of valves is a solenoid valve.

16. The system of claim 15, wherein the control circuit is further configured to determine an inductance associated with the at least one valve of the plurality of valves, based on the detected current associated with each valve of the plurality of valves and the detected voltage associated with each valve of the plurality of valves.

17. The system of claim 13, wherein the control circuit is configured to cause the plurality of valves to attenuate the fluid pressure within the CRDM such that the control rod performs at least one of an insertion sequence, a withdrawal sequence, a continuous insertion sequence, and a continuous withdrawal sequence, or combinations thereof.

18. A method of controlling a nuclear flux produced by a nuclear reactor, the method comprising:
receiving, via a control circuit of a hydraulic control unit (“HCU”), a signal from a rod drive control system (“RDCS”) module;
generating, via the control circuit of the HCU, an operations sequence based on the received signal;
attenuating, via the control circuit of the HCU, a fluid pressure within a control rod drive mechanism (“CRDM”) via the plurality of valves, such that the fluid pressure causes a control rode of the CRDM to perform the generated operation sequence;
detecting, via the control circuit of the HCU, a current associated with each valve of a plurality of valves of the HCU;
detecting, via the control circuit of the HCU, a voltage associated with each valve of the plurality of valves of the HCU;
determining, via the control circuit of the HCU, a parameter associated with each valve of the plurality of valves of the HCU based on the detected voltage and the detected current; and
determining, via the control circuit of the HCU, a status of the operation sequence based on the determined parameter.

19. The method of claim 18, wherein the determined parameter comprises at least one of a resistance associated with each valve of the plurality of valves or a temperature associated with each valve of the plurality of valves.

20. The method of claim 18, wherein the operation sequence comprises at least one of an insertion sequence, a withdrawal sequence, a continuous insertion sequence, and a continuous withdrawal sequence, or combinations thereof.
